(19) United States
(12) Patent Application Publication
(10) Pub. No.: US 2005/0176539 A1
(43) Pub. Date: Aug. 11, 2005

(54) Sprocket chain comprising nitrated joint pins

(75) Inventor: Volker Hirschmann, Furstenfeldbruck (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JOH. WINKLHOFER & SOHNE GMBH UND CO. KG, Munchen (DE)

(21) Appl. No.: 10/513,100

(22) PCT Filed: Apr. 2, 2003
(86) PCT No.: PCT/EP03/03447

(30) Foreign Application Priority Data
May 2, 2002 (DE) 202 06 947.8

(51) Int. Cl. F16G 13/02

(52) U.S. Cl. 474/228

(57) ABSTRACT

An articulated chain comprising chain links which are interconnected by respective chain hinges, a respective hinge pin extending through at least one hinge opening so as to define a chain hinges and a bearing surface of the hinge opening being formed by a sintered material, wherein the hinge pin is produced from an alloy steel and a hinge-pin boundary layer defining the bearing surface is provided with a nitrified surface layer.

The invention relates to an articulated chain comprising chain links which are interconnected by respective chain hinges, a respective hinge pin extending through at least one hinge opening so as to define a chain hinge and a bearing surface of the hinge opening being formed by a sintered material.

In the case of a link chain of the type in question, which is known from DE 20103503 U, sleeves which consist of a self-lubricating material and which are rotatably supported on a chain pin are used for obtaining a largely maintenance-free chain. The sleeves consist of a sintered material and are impregnated with a lubricant which is gradually released to the outside during the service life of the link chain. The sleeves are provided for guaranteeing lubrication between the parts of the chain moving relative to one another, the respective sleeve preventing in particular a contact between the inner and outer link plates.

JP 61184246 A describes a corrosion-resistant chain in which both the hinge pin and the hinge sleeve are provided with a titaniferous surface layer. This surface is produced in a thermochemical process at a temperature of 1000° C. and with a long process time. A titaniferous reaction gas is used for enriching the surface layer by diffusion with titanium carbide or titanium nitride, depending on the additional components of the reaction gas. When the material in question has a small thickness, the long process time has the effect that the properties of the core material will change.

The demands on the wear resistance of articulated chains, which, especially in field of automobiles, increase as a consequence of the increasing technical development, result in a constant need of improvements and in the necessity of adapting also the wear resistance. Moreover, in particular in view of the high numbers of pieces produced in the field of automobile industry, it is necessary to replace complicated and expensive solutions for problems of wear by inexpensive concepts.

It is the object of the present invention to provide an articulated chain with good wear characteristics at the lowest possible manufacturing costs.

In the case of an articulated chain of the type in question, this object is achieved in that at least one hinge-pin boundary layer defining the bearing surface is provided with a nitrided surface layer.

It is true that JP 61184266 A discloses hinge pins with a surface layer of titanium nitride, but the hinge sleeves are there coated with titanium nitride as well. DE 20103503 U aims at achieving good wear characteristics by means of sintered sleeves impregnated with a lubricant. Neither the material of the chain pins nor the nature of their surface is discussed in detail in this German publication and, in view of the sufficient amount of lubricant supplied, these properties are apparently of secondary importance. The above solutions try to improve the properties of chain hinges by a single measure. They do not suggest that, for the purpose of improving the wear problems entailed by articulated chains, the bearing surfaces of the chain hinge should be adapted to one another by selecting a material and a surface, respectively, which are adapted to the countermaterial of the hinge opening or hinge pin.

The solution according to the present invention provides, for the first time, an articulated chain which combines a hinge-opening bearing surface made of a sintered material and a hinge-pin bearing surface provided with a nitrided surface layer. All the supporting surfaces of the hinge opening and of the hinge pin which are in contact with one another in the chain hinge are defined by the bearing surfaces of the hinge opening and of the hinge pin. The nitrided surface layer of the bearing surface of the hinge pins is produced by enriching the boundary layer of the material with nitrogen during a thermochemical treatment, whereby the fatigue strength as well as the resistance to surface fatigue and adhesive wear is increased. The special combination of the materials of the bearing surfaces of the hinge opening and of the hinge pin leads to a good antifrictional behaviour of the chain hinge and, consequently, to a good resistance to wear for the whole articulated chain.

Due to the good antifrictional properties of this combination of materials, it is not necessary to lubricate the chain hinge by a lubricant released from the bearing surfaces made of sintered material and, in spite of improved wear characteristics, the demands on the surface layer of the hinge pins need not be reduced. This allows an improvement of the wear characteristics of the articulated chain, without any change of the demands on wear resistance being necessary, as well as a reduction of the manufacturing costs.

An advantageous embodiment is so conceived that the hinge pin is provided with a nitrided surface layer throughout the boundary layer defining its circumferential surface. By means of the uninterrupted nitrided surface layer along the circumferential surface of the hinge pins, weak spots can be avoided which may otherwise occur at the transition from a nitrided surface to an unnitrided surface. Areas of low wear resistance between the supporting surfaces of the hinge pin which are in contact with the bearing surface of the hinge opening can be avoided in this way.

A preferred modification is so conceived that the hinge pin is provided with a oxinitrided surface layer. The oxinitrided surface layer is produced by enriching the boundary layer of the material with nitrogen and oxygen in a thermochemical treatment. The oxinitrided surface layer is characterized by a good resistance to adhesion and by increased corrosion resistance.

According to another variant, the bearing surface of the hinge pins is provided with a carbonitrided surface layer. The carbonitrided surface layer of the bearing surface of the hinge pins is produced by enriching the boundary layer of the material with nitrogen and carbon in a thermochemical treatment, whereby iron nitride is formed on an outer connection layer. The carbonitrided surface layer increases the resistance to adhesive wear.

Another advantage is that the carbonitrided surface layer is produced by means of a short-time gas nitriding process. Short-time gas nitriding processes allow, in comparison with other nitriding processes, short process times.

The hinge pin can be produced from an alloy steel so as to obtain a sufficient hardness in the core of the hinge pin in addition to the good wear characteristics of the bearing surface.

The alloy steel can preferably be a nitriding steel, in particular a 39 CrMoV 13 9. Nitriding steels are particularly suitable for achieving a wear-resistant surface layer by means of nitriding, since nitriding steels contain special nitride-forming materials, e.g. chromium, aluminium or molybdenum.

According to an advantageous embodiment, the nitrided surface layer can comprise an outer boundary layer having a thickness of 3 to 30 μm and containing iron nitride (ε-FeₓN). Such a boundary layer consisting predominantly of iron nitride allows a high hardness of the nitrided surface layer.

An advantageous embodiment is so conceived that the nitrided surface layer has a hardness of 1000 to 1500 HV 0,1. Such a hardness of a nitrided surface layer imparts to said surface layer a very high resistance to adhesive wear.

According to one variant, it will also be advantageous when the bearing surface of the hinge opening is produced from a steel powder. The use of a steel powder for producing the sintered material used as a bearing surface will impart to the bearing surface the hardness and strength required when the articulated chain is in operation.

Another increase in the strength of the bearing surface of the hinge opening is, according to a further embodiment, achieved in that at least a part of the steel powder has added thereto at least one alloying element, in particular copper, nickel, chromium, molybdenum.

For the sake off simplicity, the bearing surface of the hinge opening can be defined by a hinge sleeve connected to a chain link. This allows the chain link and the bearing surface made of sintered material to be produced independently of one another and to be interconnected subsequently.

According to an advantageous embodiment, the hinge sleeve may fully consist of a sintered material. This prevents weak spots at the connection points between the hinge sleeve and the bearing surface. Due to the reduction of the necessary working steps for producing the hinge sleeve, it is additionally possible to reduce the manufacturing costs.

A preferred embodiment is so conceived that inner chain links, which comprise at least two inner link plates and two hinge sleeves interconnecting said inner link plates in spaced, parallel relationship with one another, and outer chain links, which comprise at least two outer link plates and two hinge pins interconnecting said outer link plates in spaced, parallel relationship with one another, are interconnected in alternating succession via respective chain hinges. Such articulated chains comprising inner chain links and outer chain links, in particular sleeve-type chains and roller-type chains, are produced in high numbers of pieces and with a high degree of automation for many fields of industry, e.g. also for the field of automobile industry. This mass production leads to correspondingly low costs of this type of articulated chains. The hinge sleeves are fixedly connected to the inner link plates, especially by pressing or by means of an adhesive. In view of the fact that the hinge sleeve is, over the whole width of the inner chain link, rotatably supported on the hinge pin provided with a chromated surface, this type of articulated chain has a large bearing surface, which means that the load on and the wear of the chain hinge will be low.

In the following, embodiments of the present invention will be explained in detail making reference to a drawing, in which:

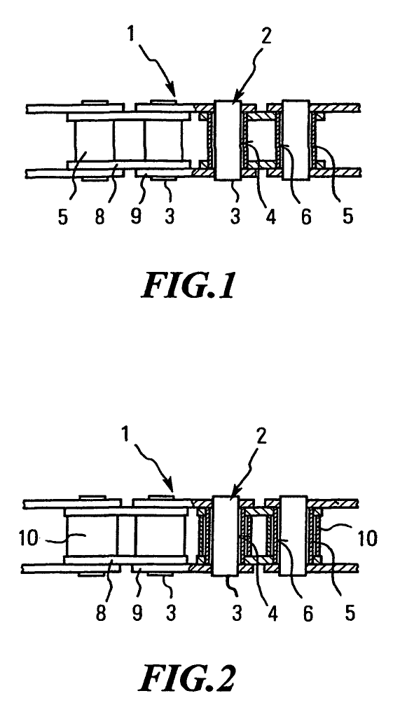

FIG. 1 shows a top view, part of which is a sectional view, of an articulated chain according to the present invention, and

FIG. 2 shows a top view, part of which is a sectional view, of a further embodiment of the articulated chain.

The articulated chain 1 according to the present invention, which is shown in FIG. 1, is implemented as a sleeve-type chain comprising inner chain links and outer chain links, the respective inner and outer chain links being interconnected by chain hinges 2. The inner chain link comprises inner link plates 8 which extend parallel to one another and two hinge sleeves 5 which interconnect said inner link plates 8, said hinge sleeves 5 extending at right angles to said inner link plates 8 and being fixedly connected to said inner link plates 8, especially by pressing or by means of an adhesive. The outer chain links comprise two outer link plates 9 which extend parallel to one-another and which are interconnected by two hinge pins 3, said hinge pins 3 being rotatably supported in the hinge sleeves 5 of the inner chain links. The outer chain link is rotatably secured to an inner chain link by means of the hinge pin 3 and connects through the outer link plates 9 the inner chain link to a second inner chain link, said outer link plates 9 extending parallel to said inner link plates 8. The hinge pins 3 of the outer chain link are rotatably supported in the hinge sleeves 5 of the inner chain link, whereby the connections define a respective chain hinge 2 of the articulated chain 1. The axes of the hinge pins 3 and of the surrounding hinge sleeves 5 are in alignment with one another.

The hinge sleeves 5 shown in FIG. 1 consist completely of a sintered material on a basis of a steel powder. The hinge sleeve 5 is a sintered composite, which means that close tolerances can be observed when said hinge sleeves 5 are produced. After final machining of the bearing surface 6, the hinge sleeves 5 are subjected to a further heat treatment.

The hinge pins 3 of the articulated chain 1 according to the present invention are produced in a gaseous diffusion process, an OCN process in the course of which ground pin material consisting of 39 CrMoV 13 9 is carbonitrided at a temperature of approx. 600° C. for a period of 60 to 120 minutes. Nitrogen and carbon diffuses from the process gas into the surface layer of the hinge pins 3 and forms an outer connection layer of iron nitride, ε-FeₓN, having a thickness of 5 to 10 μm and a hardness of 1000 to 1200 HV 0,1. Towards the interior of the hinge pins 3, said out layer is followed by a layer of y—F4₄N before a nitrogen diffusion layer is reached. The ε-FeₓN increases the resistance to adhesive wear. In the outer boundary layer of the connection layer a pore fringe exists, which is eliminated by vibratory grinding after the OCN process.

The bearing surface 6 of the hinge opening, which is produced from a sintered material, proves to be very suitable as an antifriction partner for the nitrided bearing surface 4 of the hinge pins 3, whereby good wear characteristics are obtained for the chain hinge 2 in its entirety. The wear characteristics of the chain hinge 2 can be improved once more by wetting the bearing surface 6 of the hinge sleeve 5 regularly with a lubricant. Due to the porous structure of the sintered material, the lubricant supplied from outside adheres to the bearing surfaces of the hinge sleeves 5. The porous structure also delays the release of the lubricant, which means that hinge sleeves 5 made of a sintered material have good antifrictional properties.

In the case of the embodiment of the articulated chain 1 shown in FIG. 1, which is implemented as a sleeve-type chain, the tooth profiles of the sprocket wheel engaging said chain contact the stationary hinge sleeves 5 always at the same point of the outer surface, i.e. high wear resistance or perfect lubrication will be necessary at this point. However, due to the large diameter of the hinge pins 3, sleeve-type chains have a large hinge area which results in less pressure on the hinge area and therefore less wear in the chain hinge 2.

Sleeve-type chains are used in the field of automobiles for camshaft drives subjected to high stress as well as in fast running Diesel engines.

FIG. 2 shows a further embodiment of an articulated chain 1 according to the present invention. In the following, only the essential differences between the roller-type chain shown in FIG. 2 and the sleeve-type chain according to FIG. 1 will be described. For identical elements and for elements producing the same effect, identical reference numerals will be used and, in this respect, reference will additionally be made to the above description of FIG. 1. Also in the case of the roller-type chain, the inner chain link comprises two inner link plates 8 which extend parallel to one another and two hinge sleeves 5 which interconnect said inner link plates 8, and it additionally comprises two running rollers 10 which encompass the hinge sleeves 5 between the inner link plates 8. In addition to the hinge pins 3 also the running rollers 10 extend at right angles to the inner link plates 8. The axes of the running rollers 10 surrounding the hinge sleeves 5 and of the hinge sleeves 5 surrounding the hinge pins 3 as well as of said hinge pins 3 themselves are in alignment with one another.

The running rollers 10 of a roller-type chain, which rotate on top of the hinge sleeves 5, roll with little friction on the tooth profiles of the sprocket wheel engaging said roller-type chain so that the point under load on the circumference of the running rollers 10 constantly changes. A lubricant film between the running rollers 10 and the hinge sleeves 5 contributes to noise insulation and shock absorption. Due to the fact that the diameter of the hinge pins 3 of the roller-type chain is smaller than the hinge-pin diameter of the sleeve-type chain, the chain hinges 2 of the roller-type chain have a hinge area which is smaller than that of the sleeve-type chain, i.e. the pressure on the hinge area will be higher. This higher load on the chain hinge 2 necessitates that special attention is paid to the wear characteristics in accordance with an embodiment according to the present invention where the bearing surface 6 of the hinge opening is produced from a sintered material and the bearing surface 4 of the hinge pins 3 is provided with a nitrided surface layer.

1. An articulated chain, comprising chain links interconnected by respective chain hinges, a respective hinge pin extending through at least one hinge opening so as to define a chain hinge, a bearing surface of the hinge opening being formed by a sintered material, the hinge pin being produced from an alloy steel, and a hinge-pin boundary layer defining the bearing surface being provided with a nitrided surface layer.

2. An articulated chain according to claim 1, wherein the hinge pin is provided with a nitrided surface layer throughout the boundary layer defining its circumferential surface.

3. An articulated chain according to claim 1, wherein the bearing surface of the hinge pins is provided with a oxinitrided surface layer.

4. An articulated chain according to claim 1, wherein the bearing surface of the hinge pins is provided with a carbonitrided surface layer.

5. An articulated chain according to claim 4, wherein the carbonitrided surface layer is produced by means of a short-time gas nitriding process.

6. An articulated chain according to claim 1, wherein the alloy steel of the hinge pin is a nitriding steel.

7. An articulated chain according to claim 1, wherein the nitrided surface layer comprises an outer boundary layer having a thickness in the range of approximately 3 to 30 μm and containing iron nitride.

8. An articulated chain according to claim 1, wherein the nitrided surface layer has a hardness in the range of approximately 1000 to 1500 HV 0,1.

9. An articulated chain according to claim 1, wherein the bearing surface of the hinge opening is produced from a steel powder.

10. An articulated chain according to claim 9, wherein at least a part of the steel powder has added thereto at least one alloying element.

11. An articulated chain according to claim 1, wherein the bearing surface of the hinge opening is defined by a hinge sleeve connected to a chain link.

12. An articulated chain according to claim 11, wherein the hinge sleeve consists fully of a sintered material.

13. An articulated chain according to claim, and wherein inner chain links, which comprise at least two inner link plates and two hinge sleeves interconnecting said inner link plates in spaced, parallel relationship with one another, and outer chain links, which comprise at least two outer link plates and two hinge pins interconnecting said outer link plates in spaced, parallel relationship with one another, are interconnected in alternating succession via respective chain hinges.

14. An articulated chain according to claim 6, wherein the nitriding steel is 39 CrMoV 13 9.

15. An articulated chain according to claim 10, wherein the at least one alloying element is one of copper, nickel, chromium, and molybdenum.
